(19) United States
(12) Patent Application Publication
(10) Pub. No.: US 2006/0197317 A1
(43) Pub. Date: Sep. 7, 2006

(54) AIRBAG ATTACHMENT STRUCTURE

(75) Inventor: Kazuo WATANABE, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/276,580

(22) Filed: Mar. 6, 2006

Related U.S. Application Data
(60) Provisional application No. 60/658,593, filed on Mar. 7, 2005.

(51) Int. Cl. B60R 21/217; B60R 21/213

(52) U.S. Cl. 280/728.2; 280/730.2

(57) ABSTRACT

An attachment structure for connecting an airbag to a vehicle body. The structure may include a pair of reinforcing plates configured to retain a portion of the airbag therebetween. The structure may further include a clip configured to pass through the plates, a first opening in the airbag, and a second opening in the vehicle body to connect the airbag to the vehicle body. The structure may be configured so that one of the reinforcing plates includes a hook portion that passes through the first and second openings to retaining the airbag in position along the vehicle body.

### BACKGROUND

The present application claims priority to and the benefit of U.S. Provisional Patent Application Ser. No. 60/658,593, filed on Mar. 7, 2005. The aforementioned provisional application is incorporated by reference herein in its entirety.

The application refers to a system, device and method for installing an airbag and/or an airbag module in a motor vehicle. For example, the application discloses side curtain type airbags (e.g., Head Side Airbags or HSABs), which are typically installed along the side of a vehicle. The curtain type airbags are typically designed to unfold or unroll downward to inflate between a vehicle occupant and a side of the vehicle. The side curtain airbag is contained in a module that is typically attached to a portion of the vehicle body such as, for example, a roof rail.

The present application discloses an improved structure for attaching an airbag to a vehicle body.

### SUMMARY

An embodiment of an attachment structure for connecting an airbag to a vehicle body is disclosed. The structure includes a pair of reinforcing plates configured to retain a portion of the airbag therebetween. The structure further includes a clip configured to pass through the plates, a first opening in the airbag, and a second opening in the vehicle body to connect the airbag to the vehicle body. The structure is configured so that one of the reinforcing plates includes a hook portion that passes through the first and second openings to retaining the airbag in position along the vehicle body.

In another embodiment, an attachment structure for connecting a side curtain airbag module to a vehicle body is disclosed. The airbag module includes an inflator and an airbag, and the structure includes a pair of reinforcing plates configured to retain a portion of the airbag therebetween. The structure may also include a clip including an internal fastener. The clip is configured to pass through the plates and the first and second openings so that a protruding portion of the clip is located on an opposite side of a portion of the vehicle body from the airbag to thereby fasten the clip to the vehicle body. The fastener is configured to be movable within the clip and to expand the protruding portion of the clip.

According to yet another disclosed embodiment a vehicle safety system is provided. The system includes a side airbag configured to deploy as a curtain along an interior side of a vehicle compartment, and an inflator configured to produce inflation gas for the airbag. The system may also include a mounting structure for connecting the airbag to the vehicle. The mounting structure may include a pair of reinforcing plates configured to retain a tab portion of the airbag therebetween, and a clip configured to pass through the plates, the tab portion, and a portion of the vehicle body. One of the reinforcing plates may include a hook portion that passes through the other reinforcing plate, the airbag and the vehicle body to retain the airbag in position along the vehicle body.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a side view of a side curtain type airbag module in a deployed configuration.

FIG. 2 is an exploded schematic view of a side airbag module including an attachment structure and inflator assembly.

FIG. 3 is a close-up exploded view of the attachment structure shown in FIG. 2

FIG. 4 is a cross-sectional view of the attachment structure shown in FIG. 2 in an assembled state.

FIGS. 5a-5c are cross sectional views of the attachment structure shown in FIG. 2 during the process of attaching an airbag module to a vehicle body.

FIG. 6 is a perspective view of a clip portion of an airbag attachment structure.

FIG. 7 is a perspective view a clip and fastener arrangement of an airbag attachment structure.

### DESCRIPTION

The present application relates to a simplified system for installing an airbag or airbag module in a vehicle. In particular, the present application discloses simplified system for installing a side curtain type airbag, or a head side curtain type airbag (HSAB) or module in a vehicle.

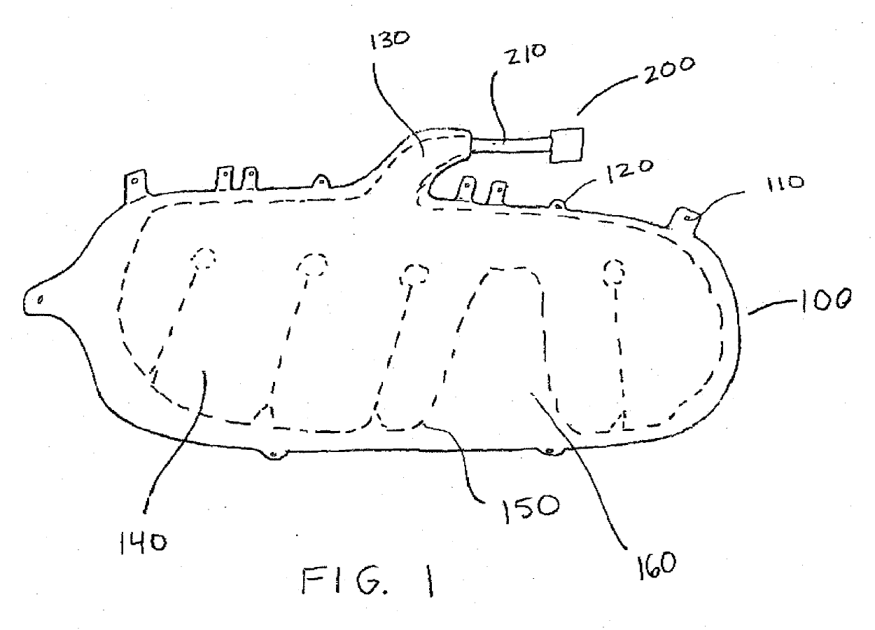

FIG. 1 discloses an exemplary airbag arrangement. The airbag 100 may include several inflatable compartments or chambers 140. The border for the chambers 140 is formed by stitching 150. The stitching 150 connects two airbag panels together to form an inflatable airbag. Although, the airbag 100 may be formed from two fabric panels, in another embodiment the airbag is formed from a single fabric or material panel or layer. The arrangement of the chambers 140 shown in FIG. 1 is for exemplary purposes only. The airbag chambers 140 may be positioned as appropriate depending on the design of the vehichle.

The airbag 100 may include connecting tabs 110 provided to facilitate attachment of the airbag 100 to the vehicle structure. The connecting tabs 100 are positioned to attach to the vehicle body and are preferably formed from one of the two fabric panels forming the airbag. The airbag 100 may also include a inflator opening and conduit 130 for carrying inflation gas from an inflator 200 to the inflatable chambers of the airbag. As shown in FIG. 1, the conduit 130 may be positioned at a central location of the bags however in an alternative embodiment, the inflation gas carrying conduit may be positioned at an end of the airbag or along the entire top portion of the bag, for example, as appropriate.

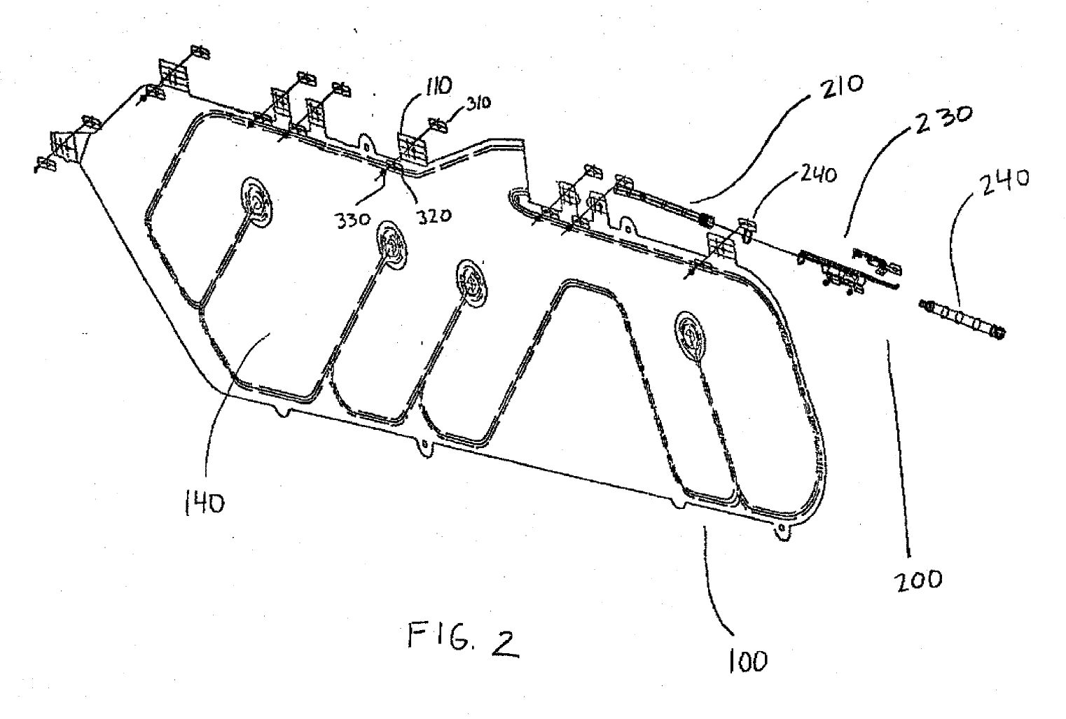

As shown in FIG. 2, the inflator assembly 200 includes a housing 240 for storing propellant and a tube 210 for carrying inflation gas to the airbag. In another embodiment, either the tube 210 or the housing 240 or both could be arranged inside the airbag to provide a compact design and to more reliably provide inflation gas to the airbag chambers. As shown, the inflator assembly is exemplary only. According to another embodiment, an airbag module may include a side curtain airbag including a cascade type inflator extending along substantially the entire length of the airbag.

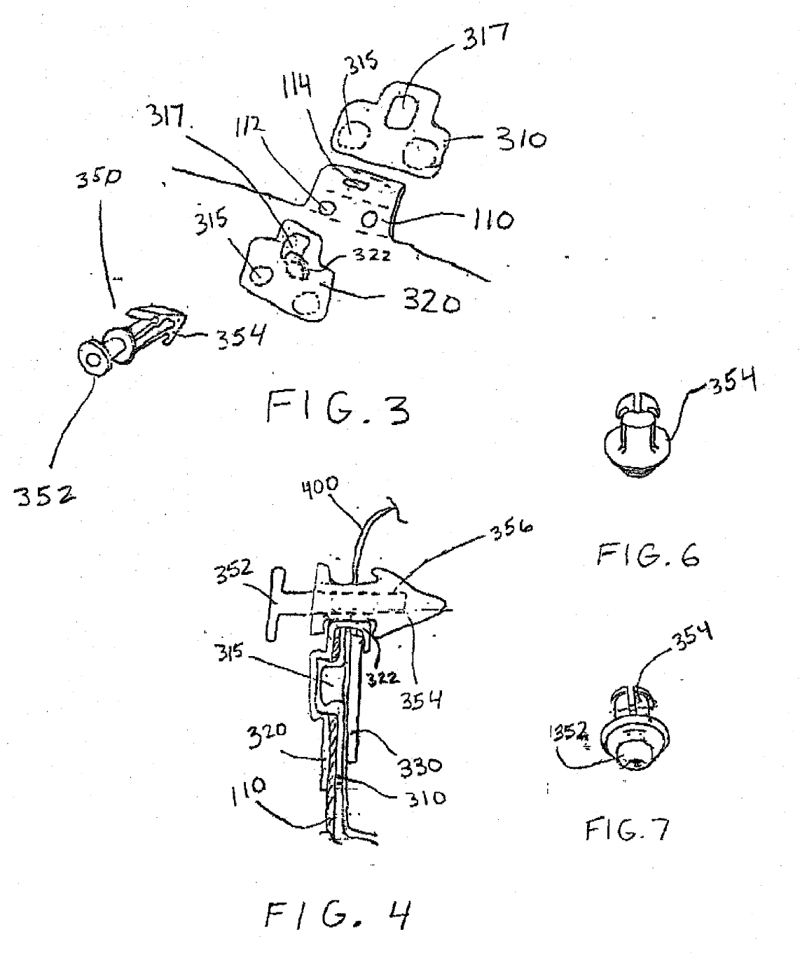

FIG. 2 also discloses an exemplary attachment structure for the airbag. The attachment structure includes an inner reinforcing plate 320 and an outer reinforcing plate 310. The plates are arranged to sandwich the connecting tab 110. The tab 110 may be integrally formed with one or both the fabric panels for forming the airbag. The attachment structure also includes a fastening device 350 for connecting the plates 310, 320 and connecting tab 110 to a portion of the vehicle body. As shown in FIG. 2, the attachment structure may be employed at multiple locations along the perimeter of the airbag. FIG. 3 provides a close up view of the attachment structure.

As shown in FIG. 3, the fastening device 350 may include two portions, a clip 354 and an insertable fastener 352. The fastening device 350 is configured to pass through an opening 114 in the connecting tab 110 and openings 317 in the inner and outer reinforcing plates 320, 310. The inner reinforcing plates 320 also may include an optional hook portion 322, which is more clearly shown in FIG. 4. Also, each of the reinforcing plates 310, 320 may include raised protrusions 315. Each protrusion in the outer plate 310 is configured to pass through an opening 112 in the connecting tab 110 and fit within a corresponding protrusion 315 in the inner plate 320. The fitted protrusions serve to reduce relative movement between the connecting tab 110, the inner plate 320 and the outer plate 310.

As shown in FIG. 4, the attachment structure is connected to a portion of the vehicle body 400. In certain embodiments, the portion of the vehicle body 400 corresponds to the roof side rail portion of the vehicle frame. The attachment structure may also include another reinforcement plate 330 located in the vehicle body on an opposite side from the airbag module. When finally arranged, the fastening device 350 is inserted through the vehicle body 400 to hold the airbag module in position. The clip portion 356 of the fastening device includes protrusions that engage the vehicle body and the hook portion 322 of the inner plate 320 to firmly attach the airbag structure to the vehicle body 400. Also, the clip portion 356 includes an inner cavity 356 which is configured to receive the fastener 352. As the fastener 352 moves into the clip 356, the protruding portions of the clip 356 are forced outward creating a secure engagement with the vehicle body 400 and preventing the fastening device 350 from being separated from the vehicle body 400.

FIGS. 6 and 7 show an exemplary embodiment for the fastening device 340. FIG. 6 shows an exemplary arrangement for the clip portion 354. As shown in FIG. 6 the clip may include bendable or flexible leg portions that may be forced outward by the insertable fastener. The leg portions may be separated by slots along the longitudinal axis of the hook portion 354. FIG. 7 discloses an exemplary embodiment for the fastener portion 352 and clip portion 354. The fastener portion 352 may be any suitable type of fastener such as, for example, a screw type threaded fastener. A washer may also be provided between the fastener and clip portions.

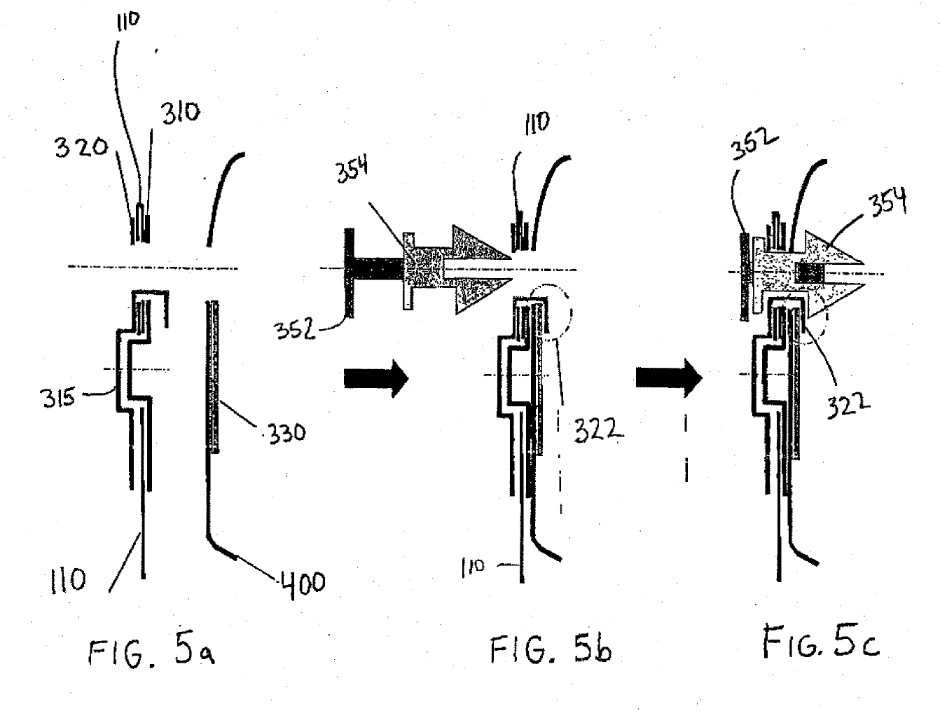

FIGS. 5a-5c disclose the process for attaching the airbag module to the vehicle body. As shown in Fig. 5a, the assembled module is positioned alongside a portion of the vehicle body 400. The airbag connecting tab 110 may be folded over and arranged between the reinforcing plates 320, 310. As shown in FIG. 5a, the hook portion 322 of the inner reinforcing plate extends through an opening in the connecting tab 110.

As shown in FIG. 5b, the airbag module may be connected to the vehicle body, by placing the hook portion 322 through the opening in the vehicle body and over the reinforcement plate 322 located on the opposite side. The connection of the hook portion 322 serves to temporarily join the airbag module to the vehicle body. After insertion of the clip portion 354 of the fastening device 350, as shown in Fig. 5c, the hook portion 322 more securely retains the module in position. Also, FIG. 5c depicts the fastening device 350 with the fastener 352 fully inserted into the clip portion 354. When the clip 354 is initially inserted into the vehicle body 400, the fastener portion 352 remains extended out of the clip 354, as shown in FIG. 5b.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

WHAT IS CLAIMED IS:

1. An attachment structure for connecting an airbag to a vehicle body comprising:
a pair of reinforcing plates configured to retain a potion of the airbag therebetween;
a clip configured to pass through the plates, a first opening in the airbag, and a second opening in the vehicle body to connect the airbag to the vehicle body; and
wherein one of the reinforcing plates includes a hook portion that passes through the first and second openings to retaining the airbag in position along the vehicle body.

2. The structure of claim 1, further comprising a fastener insertable within the clip and configured to expand protruding portions of the clip positioned on an opposite side of a portion of the vehicle body from the airbag to thereby fasten the clip to the vehicle body.

3. The structure of claim 2, wherein the fastener includes a threaded stem.

4. The structure of claim 1, wherein one of the reinforcing plates includes a protruding portion that protrudes through a third opening in the airbag.

5. The structure of claim 1, further comprising a third reinforcement plate located on the opposite side of the vehicle body from the airbag.

6. The structure of claim 5, wherein the hook portion extends through the vehicle body to a position on an opposite side of the third reinforcement plate from the airbag.

7. An attachment structure for connecting a side curtain airbag module to a vehicle body, wherein the airbag module includes an inflator and an airbag, the structure comprising:
a pair of reinforcing plates configured to retain a portion of the airbag therebetween; and
a clip including an internal fastener, wherein the clip configured to pass through the plates and the first and second openings so that a protruding portion of the clip is located on an opposite side of a portion of the vehicle body from the airbag to thereby fasten the clip to the vehicle body, wherein the fastener is movable within the clip and to expand the protruding portion of the clip.

8. The structure of claim 7, wherein one of the reinforcing plates includes a hook portion that passes through a first opening in the airbag and a second opening in the vehicle body to provide a temporary retaining structure prior clipping the airbag to the vehicle body.

9. The structure of claim 7, wherein the fastener includes a threaded stem.

10. The structure of claim 7, wherein one of the reinforcing plates includes a protruding portion that protrudes through a third opening in the airbag.

11. The structure of claim 7, further comprising a third reinforcement plate located on the opposite side of the vehicle body from the airbag.

12. The structure of claim 11, wherein the hook portion extends through the vehicle body to a position on an opposite side of the third reinforcement plate from the airbag.

13. A vehicle safety system comprising;
a side airbag configured to deploy as a curtain along an interior side of a vehicle compartment;
an inflator configured to produce inflation gas for the airbag;
a mounting structure for connecting the airhag to the vehile, wherein the mounting structure includes:
a pair of reinforcing plates configured to retain a tab portion of the airbag therebetween;
a clip configured to pass through the plates, the tab portion, and a portion of the vehicle body;
wherein one of the reinforcing plates includes a hook portion that passes through the other reinforcing plate, the airbag and the vehicle body to retain the airbag in position along the vehicle body.

14. The system of claim 13, further comprising a fastener movable within the clip and configured to expand protruding portions of the clip positioned on an opposite side of a portion of the vehicle body from the airbag to thereby fasten the clip to the vehicle body.

15. The system of claim 13, wherein one of the reinforcing plates includes a protruding portion that passes through an opening in the airbag.

16. The system of claim 15, wherein the protruding portion fits within a corresponding recessed portion of the other reinforcing plate to thereby reduce relative movement of the plates and the airbag therebetween.
